(19) United States
(12) Patent Application Publication
(10) Pub. No.: US 2017/0352064 A1
(43) Pub. Date: Dec. 7, 2017

(54) SYSTEMS AND METHODS FOR OPTIMIZING PROPERTY VALUATIONS AND APPRAISALS

(71) Applicant: MasterCard International Incorporated, Purchase, NY (US)

(72) Inventors: Stephen Andrew Gerhard, San Francisco, CA (US); Scott Hudson, Pearl River, NY (US)

(21) Appl. No.: 15/171,999

(22) Filed: Jun. 2, 2016

(51) Int. Cl. G06Q 30/02; G06Q 50/16

(52) U.S. Cl. CPC G06Q 30/0278; G06Q 30/0282; G06Q 50/16

(57) ABSTRACT

A valuation computing device for optimizing a valuation of a property is provided. The valuation computing device includes a processor coupled to a memory and a database. The processor is programmed to receive a property location of a candidate property and a predefined distance that defines a geographical area including the property location, calculate an impact area including at least one merchant within the predefined distance, retrieve a list of merchants within the impact area and transaction data associated with the retrieved list of merchants from the database, analyze the retrieved transaction data to determine which merchants of the retrieved list of merchants are currently operating, generate merchant data for the operating merchants based on the transaction data associated with the operating merchants, and determine a proximity-to-commerce value of the candidate property based on the generated merchant data.

### BACKGROUND

The field of the disclosure relates generally to generating appraisals and valuations for a property and, more particularly, to network-based systems and methods for generating an optimized valuation of a property that includes a property value component and a location value component, wherein the location value component is verified with transaction data.

At least some known appraisal and valuation systems generate reports by evaluating individual property infrastructure. Often the property appraisal and valuation are based on infrastructure characteristics, such as lot size, number of rooms, number of bathrooms, and other elements related to the building on the property and/or the property itself (sometimes referred to as the “infrastructure value”). However, to complete the evaluation, the appraiser must assess the “location value” of the property and include it in the overall property valuation. In other words, the overall property value of a piece of property includes both an infrastructure value component plus a location value component.

In some instances, the location value of the property is calculated based on the number of merchants open for business and the proximity-to-commerce to the property. The number of merchants and the distance from the merchants open for business may be miscalculated for reasons including human error, incorrect data or data that is not up to date. When these calculations are incorrect the location value of the property is also incorrect. This may cause the property to be purchased and/or sold at an incorrect price.

One known method for ensuring a merchant is open for business is to have a user manually survey the surrounding area to determine the location value of the property. This manual survey typically includes driving through the area surrounding the property location and/or performing a web search. In many cases, this manual survey fails to account for several factors essential to the valuation. For example, the user may fail to discover certain merchant locations, or may incorporate merchants that are no longer in business. Additionally, these forms of searching (e.g., manual and web based) are time consuming and inefficient. As a result, appraisers may incorrectly value a property location.

Accordingly, it would be desirable to have a system that generates an optimized valuation for a piece of property that includes a property value component and a location value component, wherein the location value component is verified with transaction data that verifies the number of active merchants within a surrounding area of the property.

### BRIEF DESCRIPTION OF THE DISCLOSURE

In one aspect, a valuation computing device for optimizing a valuation of a property is provided. The valuation computing device includes a processor coupled to a memory and a database. The processor is programmed to receive a property location of a candidate property and a predefined distance that defines a geographical area including the property location, calculate an impact area including at least one merchant within the predefined distance, retrieve a list of merchants within the impact area and transaction data associated with the retrieved list of merchants from the database, analyzing the retrieved transaction data to determine which merchants of the retrieved list of merchants are currently operating, generate merchant data for the operating merchants based on the transaction data associated with the operating merchants, and determine a proximity-to-commerce value component for the candidate property based on the generated merchant data.

In another aspect, a method for optimizing a valuation of a property is provided. The method is at least partially implemented by a valuation computing device. The method includes receiving a property location of a candidate property and a predefined distance defining a geographical area including the property location, calculating an impact area including at least one merchant within the predefined distance, retrieving, from a database, a list of merchants within the impact area, retrieving, from the database, transaction data associated with the retrieved list of merchants, analyzing the retrieved transaction data to determine which merchants of the retrieved list of merchants are currently operating, generating merchant data for the operating merchants based on the transaction data associated with the operating merchants, and determining a proximity-to-commerce value component for the candidate property based on the generated merchant data.

In yet another aspect, at least one non-transitory computer-readable storage media having computer-executable instructions embodied thereon is provided. When executed by at least one processor, the computer-executable instructions cause the processor to receive a property location of a candidate property and a predefined distance defining a geographical area including the property location, calculate an impact area including at least one merchant within the predefined distance, retrieve, from a database, a list of merchants within the impact area, retrieve, from the database, transaction data associated with the retrieved list of merchants, analyze the retrieved transaction data to determine which merchants of the retrieved list of merchants are currently operating, generate merchant data for the operating merchants based on the transaction data associated with the operating merchants, and determine a proximity-to-commerce value component for the candidate property based on the generated merchant data.

### BRIEF DESCRIPTION OF THE DRAWINGS

The Figures listed below show example embodiments of the methods and systems described herein.

FIG. 1 is a schematic diagram illustrating an example property valuation platform that includes a payment processing system in communication with a valuation computing device for generating an optimized valuation of a property in accordance with one embodiment of the present disclosure.

FIG. 2 is a block diagram of the property valuation platform that includes the valuation computing device and the payment processing system as shown in FIG. 1.

FIG. 3 illustrates an example configuration of a server system as shown in FIG. 2.

FIG. 4 is a data flow block diagram illustrating an example data flow using the property valuation platform shown in FIG. 1.

FIG. 5 is a data flow block diagram illustrating an example data flow using the property valuation platform shown in FIG. 1.

FIG. 6 is a data flow block diagram illustrating an example data flow using the property valuation platform shown in FIG. 1.

FIG. 7 is an example computer-implemented method for valuing a property location using the property valuation platform shown in FIG. 1.

### DETAILED DESCRIPTION OF THE DISCLOSURE

The present embodiments are directed to systems and methods for appraising and valuing a piece of property that includes both a property value component and a location value component. More specifically, the systems and methods described herein are configured to generate an optimized valuation of a property that includes a property value component and a location value component, wherein the location value component is verified using transaction data. The system described herein is sometimes referred to as a property valuation platform that includes a payment processing system for processing payment transactions that are initiated by cardholders with merchants, and a valuation computing device that is in communication with the payment processing system. The valuation computing device is configured to generate the optimized valuation of a candidate property by retrieving transaction data processed and stored within the payment processing system to determine the proximity-to-commerce to the candidate property. That is, the valuation computing device verifies a number of operating merchants within a predefined radius of the candidate property along with other parameters relating to the value of the candidate property that can be ascertained from the transaction data. Based on the number of operating merchants within the predefined area, a location value component (e.g., a value of the location itself, city vs. rural) can be determined. The location value is then added to the building value to produce the overall property value.

In the example embodiment, the valuation computing device is communicatively coupled to a plurality of client systems associated with parties interested in receiving a property valuation. The client systems may communicate with the valuation computing device through a web interface or a software application installed at the client systems. To initiate the valuation of a property, a user of a client system provides a location of a candidate property (also known as a “property location”) to the valuation computing device. The property location may include an address, Global Positioning System (GPS) coordinates, and the like. In addition to the property location, the valuation computing device receives a predefined distance or range from the property location. In the example embodiment, the predefined distance is a physical distance (e.g., miles, meters, etc.) from the property location. Additionally or alternatively, the predefined distance may be a travel range. For example, the predefined distance may define a region that is within ten minutes of the candidate property by public transportation.

The valuation computing device calculates an impact area within the predefined distance for subsequent location analysis. As used herein, an impact area is a geographical region including the candidate property. In the example embodiment, the impact area is calculated to include each merchant within the predefined distance. In such embodiments, the valuation computing device may receive initial transaction data from the payment processing system or perform an online lookup to identify the merchants within the predefined distance. In other embodiments, the impact area may be calculated based on other factors, such as travel distance, number of blocks from the candidate property, neighborhood limits, and the like. In certain embodiments, the user of the client system requesting valuation of the candidate property may selectively adjust the impact area.

The valuation computing device is configured to determine position coordinates (e.g., GPS coordinates) of the impact area and retrieve a list of merchants from the payment processing system based on the determined coordinates. The payment processing system may include a database configured to store the list of merchants. The merchants operate or have operated previously within the impact area. In some embodiments, the valuation computing device may also retrieve a list of merchants outside of the impact area for comparison as described herein. The valuation computing device is further configured to retrieve transaction data associated with the list of merchants to verify whether or not the merchants are actually still operating. More specifically, the valuation computing device analyzes recent transactions associated with each merchant to determine if the merchant is still operating within the impact area. If the transaction date of the latest transaction associated with a merchant is not within a predetermined time period (e.g., the previous week, month, etc.), the merchant may not be operating within the impact area anymore (known as a “non-operating merchant”).

Once the operating merchants have been verified, the valuation computing device is configured to analyze the transaction data associated with the operating merchants to generate merchant data. The merchant data includes information and metrics about the operating merchants to be used to calculate the location value component. The merchant data may include, for example, but is not limited to, revenue, transaction volume, ticket size, ticket velocity, merchant category (e.g., restaurant, hardware, electronics, clothing, etc.), type of merchant store (e.g., mall storefront, stand-alone building), and customer data. The customer data includes aggregated data associated with customers of the merchant, such as where the customers of the merchant reside. For example, it may be beneficial to know what percentage of customers of the merchant resides within the impact area. In some embodiments, the valuation computing device may be configured to determine a merchant category associated with each operating merchant. For example, the valuation computing device may retrieve the merchant category from the transaction data. In another example, the valuation computing device performs a lookup in a memory (e.g., a database coupled to the payment processing system) to determine the merchant category. In yet another example, the valuation computing device may analyze particular products purchased from the operating merchants to identify the merchant category.

In addition, the merchant data may also include merchant rankings and merchant trends. The valuation computing device is configured to compare the merchant data for each operating merchant to rank the merchants. In some embodiments, the valuation computing device may receive and/or generate merchant data for merchants outside of the impact area and compare the merchant data of the merchants outside of the impact area to the merchant data of the operating merchants within the impact area. The valuation computing device ranks the operating merchants based on the comparison. The comparisons may be performed for each merchant category such that restaurants are compared to other restaurants and gas stations and compared to other gas stations to determine merchant rankings. The merchant trends indicate whether the operating merchant is trending up or down in a particular aspect, such as ticket size or ticket velocity. In some embodiments, the transaction data of the operating merchants includes current transaction data (i.e., transaction data after a predefined date threshold) and historical transaction data (i.e., transaction data before a predefined date threshold). The valuation computing device may compare the current and historical transaction data to determine a merchant trend for each merchant. In certain embodiments, the valuation computing device may compare the operating merchants to each other or other merchants to determine relative merchant trends.

In the example embodiment, the valuation computing device is configured to determine one or more proximity-to-commerce values for the candidate property based on the merchant data of the operating merchants. The proximity-to-commerce values may be aggregated, calculated, or otherwise derived from at least a portion of the merchant data. The valuation computing device determines the location value component based in part on the proximity-to-commerce values. The location value component is also based on other location-based information, such as real estate data, median household income in the area, and so forth. The valuation computing device may be in communication with a remote computing device or database that includes the location-based information. The location value component may be a score or other metric for measuring the value of the location of the candidate property. In one embodiment, the proximity-to-commerce value is a multiplier that is applied to the location value component.

The valuation computing device is configured to generate an infrastructure value component based on infrastructure characteristics (e.g., lot size, number of bedrooms and bathrooms, square feet, etc.) of the candidate property. The infrastructure characteristics may be received from the user requesting the valuation of the candidate property. Alternatively, the infrastructure characteristics may be retrieved from a database configured to store infrastructure characteristics of properties. Once the location value component and the infrastructure value component have been determined, an overall value of the candidate property is determined by the valuation computing device based on the location and infrastructure value components. In at least some embodiments, the overall value may be a valued price or a valued price range for the candidate property. For example, a candidate property may be valued at $100,000 or $90,000-$110,000.

The valuation computing device is configured to provide the overall value of the candidate property to the user requesting the valuation. In at least some embodiments, the valuation computing device generates a value report associated with the candidate property and transmits the value report to the client system of the user. The value report includes the overall value, other values, scores, rankings, metrics, trends, and/or other data associated with the candidate property. In particular, the value report may include information associated with the proximity-to-commerce of the candidate property, such as merchant data and the proximity-to-commerce value. The valuation computing device causes the value report to be displayed on an interactive display of the client system to enable the user to access, review, and interact with the value report. For example, the value report may be configured to enable the user to filter the value report to data associated with a specific merchant category. In another example, the value report may include a visual representation of the impact area that the user may select a sub-region of the impact area to limit the data of the value report to that specific sub-region. The user can analyze the value report to make informed decisions (e.g., buy, sell, rent, lease, etc.) about the candidate property or other properties near the candidate property.

At least one of the technical problems addressed by this system may include: (i) inability to locate the physical location of a merchant; (ii) difficulty locating a merchant, (iii) accidently identifying a merchant as still in business when the merchant is actually no longer operating; (iv) difficulty locating merchants in a timely manner; and (v) inaccurately identifying a merchant's physical locations.

The technical effect achieved by this system may be at least one of: (i) improved valuation of a location surrounding a candidate property and, in particular, valuating the proximity-to-commerce of the candidate property; (ii) improved accuracy of verifying a merchant is still operating (i.e., open for business); and (iii) improved overall property valuation of a candidate property.

More specifically, the technical effects can be achieved by performing at least one of the following steps: (i) receiving a property location of a candidate property and a predefined distance, the predefined distance defining a geographical area including the property location; (ii) calculating an impact area including at least one merchant within the predefined distance; (iii) retrieving, from a database, a list of merchants within the impact area; (iv) retrieving, from the database, transaction data associated with the retrieved list of merchants; (v) analyzing the retrieved transaction data to determine which merchants of the retrieved list of merchants are currently operating; (vi) generating merchant data for the operating merchants based on the transaction data associated with the operating merchants; and (vii) determining a proximity-to-commerce value component for the candidate property based on the generated merchant data.

As used herein, the term “property location” refers to a physical address or location coordinates (e.g., GPS coordinates). Typically, the property location is the location of a house, a commercial building or a land lot being reviewed by the user. The property location is used to determine the location associated with the location value. For example, if the property being examined by the user is a residential property the property location would the address of a home. The property location is generally the base or center where the predefined distance emanates. For example, if the user input indicates a ½ mile radius around a candidate property, then the center location is the property address. A further example, if the user input indicates a two block area, the location distance will be two blocks from the property location input by the user.

As used herein, the term “location value” refers to the value associated with a geographical area surrounding a property. This value does not take into account infrastructure of the property itself. The location value is based on where the property is physically situated and the type of area surrounding the property. In the example embodiment, the location value is based in part on the proximity-to-commerce of the property. For example, a two bedroom two bathroom home in the same relative location as a five bedroom seven bath home will have the same relative location value.

As used herein, the term “infrastructure value” refers to the worth or value of the infrastructure characteristics of the property itself. The infrastructure value takes into account the characteristics of the property, such as number of bedrooms and bathrooms, building material, major renovations, square feet, and so forth. The infrastructure value does not take into account the location of the property. For example, in the same location, a two bedroom two bathroom home will have a lower infrastructure value than a five bedroom seven bathroom home. Further, a two bedroom two bathroom home may have the same infrastructure value irrespective of location.

As used herein, the term “operating merchant” refers to a merchant that is open for business at a physical merchant storefront. Some merchants may have a brick and mortar storefront that is still listed as open but has actually gone out of business. In other instances, merchants may have taken down their brick and mortar storefront but still have an online store. To qualify as an operating merchant, the merchant must have at least one transaction occurring at the brick and mortar store front within a predetermined time period that has already past (i.e., the past five days).

As used herein, a “processor” may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, or to a relational database management system (RDBMS), or both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL®, IBM® DB2, Microsoft® SQL Server, Sybase®, and PostgreSQL. However, any database may be used that enables the systems and methods described herein. (Oracle and MySQL are registered trademarks of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.) As used herein, the term “database system” refers specifically to a RDBMS.

As used herein, the term “swipe” a payment card includes a physical swipe of an actual payment card within a reader of the remote computing device, or any other action used to gather account data from a cardholder and send to the POS device. The cardholder initiates the transaction between the cardholder and the merchant by “swiping” the payment card at the remote computing device associated with a merchant. Once the card is swiped the remote computing device collects data associated with the transaction and formats the data into an authorization request message. The data collected includes, at least, an account ID (PAN), a transaction amount, a merchant ID, and a local transaction date and a transaction time. The authorization message is then sent to the acquiring bank associated with the merchant. Once the acquiring bank has parsed and/or stored the received data. The acquiring bank sends the data to the associated payment processor over the payment network. The data may be in the same form as when it reached the acquiring bank or the acquiring bank may change the form of the data before sending the data to the payment processor.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to managing computing infrastructures.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

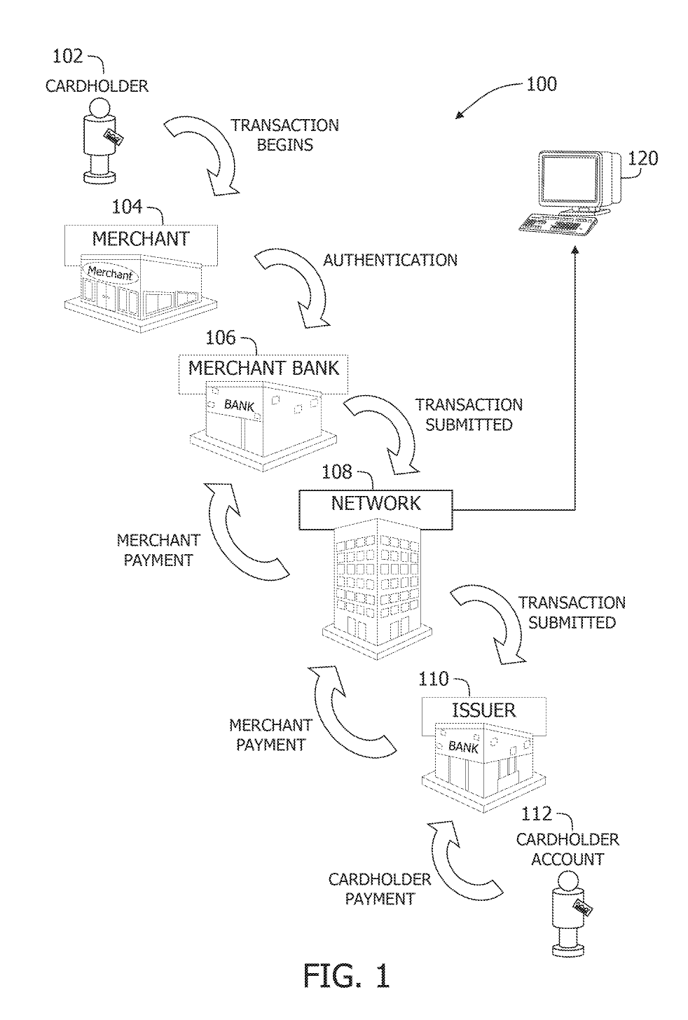

FIG. 1 is a schematic diagram illustrating an example property valuation platform 100 that includes an interchange network 108 in communication with a valuation computing device 120 for generating an optimized valuation of a candidate property in accordance with one embodiment of the present disclosure. Embodiments described herein may relate to transaction card system, such as a credit card payment system using the MasterCard® interchange network. The MasterCard® interchange network is a proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 102, who uses the transaction card to tender payment for a purchase from a merchant 104. To accept payment with the transaction card, merchant 104 must normally establish an account with a financial institution that is part of the financial payment system. This financial institution is usually called the “merchant bank,” the “acquiring bank,” or the “acquirer.” When cardholder 102 tenders payment for a purchase with a transaction card, merchant 104 requests authorization from a merchant bank 106 for the amount of the purchase. The request may be performed over the telephone, but is usually performed through the use of a point-of-sale terminal, which reads the account information of cardholder 102 from a magnetic stripe, a chip, or embossed characters on the transaction card and communicates electronically with the transaction processing computers of merchant bank 106. Alternatively, merchant bank 106 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 108, computers of merchant bank 106 or merchant processor will communicate with computers of an issuer bank 110 to determine whether cardholder account 112 of cardholder 102 is in good standing and whether the purchase is covered by the available credit line of cardholder 102. Based on these determinations, the request for authorization will be declined or accepted. If the request is accepted, an authorization code is issued to merchant 104.

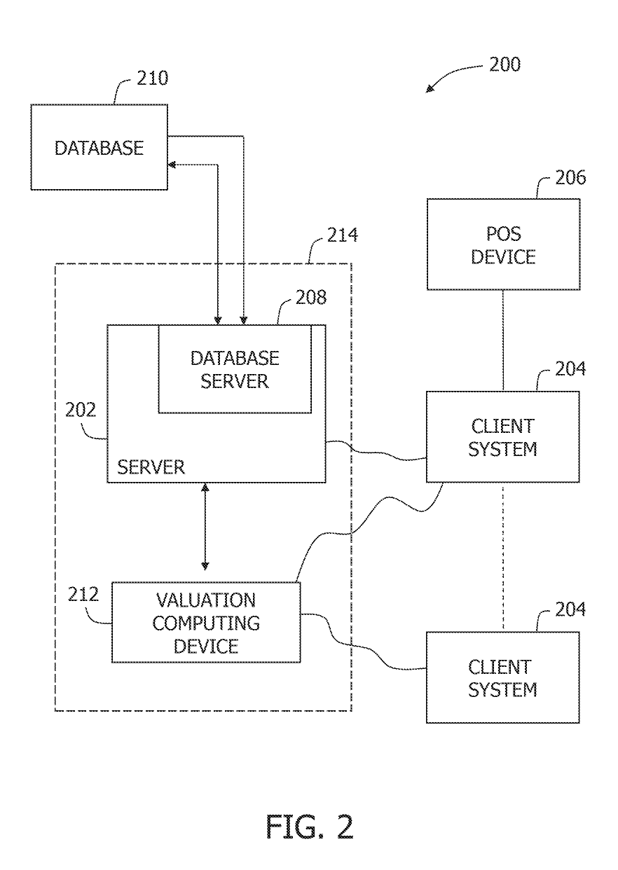

When a request for authorization is accepted, the available credit line of cardholder account 112 is decreased. Normally, a charge for a payment card transaction is not posted immediately to cardholder account 112 because bankcard associations, such as MasterCard International Incorporated®, have promulgated rules that do not allow merchant 104 to charge, or “capture,” a transaction until goods are shipped or services are delivered. However, with respect to at least some debit card transactions, a charge may be posted at the time of the transaction. When merchant 104 ships or delivers the goods or services, merchant 104 captures the transaction by, for example, appropriate data entry procedures on the point-of-sale terminal. This may include bundling of approved transactions daily for standard retail purchases. If cardholder 102 cancels a transaction before it is captured, a “void” is generated. If cardholder 102 returns goods after the transaction has been captured, a “credit” is generated. Interchange network 108 and/or issuer bank 110 stores the transaction card information, such as a type of merchant, amount of purchase, date of purchase, in a database 208 (shown in FIG. 2).

After a purchase has been made, a clearing process occurs to transfer additional transaction data related to the purchase among the parties to the transaction, such as merchant bank 106, interchange network 108, and issuer bank 110. More specifically, during and/or after the clearing process, additional data, such as a time of purchase, a merchant name, a type of merchant, purchase information, cardholder account information, a type of transaction, savings information, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among merchant 104, merchant payment card bank 106, and issuer bank 110. Settlement refers to the transfer of financial data or funds among an account of merchant 104, merchant bank 106, and issuer bank 110 related to the transaction. Usually, transactions are captured and accumulated into a “batch,” which is settled as a group. More specifically, a transaction is typically settled between issuer bank 110 and interchange network 108, and then between interchange network 108 and merchant bank 106, and then between merchant bank 106 and merchant 104.

In the example embodiment, the multi-party payment card industry system 100 includes an appraisal and valuation computing device 120 that is in communication with interchange network 108 (also referred to as payment network). The valuation computing device 120 is configured to: (i) retrieve transaction messages (e.g., authorization messages, clearing messages, and/or settlement messages) processed by interchange network 108 and stored within a database associated with interchange network 108; (ii) parsing the transaction messages to capture a physical or virtual location generated by the POS device and a merchant associated with each transaction message, (ii) determine which merchants within a geographical area are operating based on the transaction messages, (iii) generate merchant data associated with the operating merchants, and/or (iv) determine a property value of a property based in part on the proximity-to-commerce from the merchant data. The valuation computing device 120 stores the transaction data collected from transactions with merchants 104 and cardholders 102 in memory for subsequent analysis. In certain embodiments, interchange network 108 may be configured to provide at least some of the features of the valuation computing device 120.

FIG. 2 is a block diagram of an exemplary property valuation platform 200 that includes valuation computing device 212 and payment processing server 202. Platform 200 is similar to platform 100 shown in FIG. 1, and interchange network 108 is similar to payment processing server 202. Valuation computing device 212 is similar to valuation computing device 120 shown in FIG. 1.

In the example embodiment, system 200 includes a plurality of client sub-systems, also referred to as client systems 204, communicatively coupled to payment processing server 202 and valuation computing device 212. In one embodiment, client systems 204 are computers including a web browser, such that payment processing server 202 is accessible to client systems 204 using the Internet. Client systems 204 are interconnected to the Internet through many interfaces including a network, such as a local area network (LAN) or a wide area network (WAN), dial-in-connections, cable modems and special high-speed ISDN lines. Client systems 204 could be any device capable of interconnecting to the Internet including a web-based phone, personal digital assistant (PDA), or other web-based connectable equipment.

In the example embodiment, at least one client system 204 is in communication with a POS device 206. POS device 206 is configured to capture and transmit authorization data associated with one or more transactions. In some embodiments, POS device 206 may be located at a merchant. Alternatively, POS device 206 may capture authorization data associated with remote (e.g., online) transactions. POS device 206 is configured to generate at least a portion of the transaction data associated with a transaction. For example, POS device 206 may generate transaction data including a merchant identifier (e.g., a merchant's name or address), a cardholder identifier, a PAN, a date and time stamp when the transaction occurred, a merchant location, a merchant category (e.g., restaurant, clothing, hardware, etc.), a payment amount, and one or more product identifiers identifying one or more goods or services purchased.

System 200 further includes a database server 208 connected to a database 210 containing information on a variety of matters, as described below in greater detail. In one embodiment, centralized database 210 is stored on payment processing server 202 and can be accessed by potential users at one of client systems 204 by logging onto payment processing server 202 through one of client systems 204. In an alternative embodiment, database 210 is stored remotely from payment processing server 202 and may be non-centralized.

As described below, database 210 stores transaction data generated as part of sales activities conducted over the payment network including data relating to merchants, account holders or customers, and purchases. Database 210 further includes data relating to geographical locations of merchant storefronts and property valuation.

In the example embodiment, payment processing server 202 is in communication with valuation computing device 212. As used herein, payment processing server 202 and valuation computing device 212 may be referred to collectively as a host computing system 214. The functions described herein of host computing system 214 may be performed by payment processing server 202 and/or appraisal and valuation computing device 212. In some embodiments, payment processing server 202 and valuation computing device 212 may be the same computing device.

Host computing system 214 is configured to collect and store transaction data from a payment network (e.g., interchange network 108, shown in FIG. 1). For example, host computing system 214 may receive transaction data collected at POS device 206. In some embodiments, host computing system 214 may be configured to examine the transaction data to determine which transactions are from physical merchant locations and which transaction are from virtual merchant locations, such as an online merchant's website. In such embodiments, host computing system 214 may store the transactions associated with physical merchant location. In other embodiments, host computing system 214 may not distinguish the transactions of the physical and virtual merchant locations when the transaction data is received.

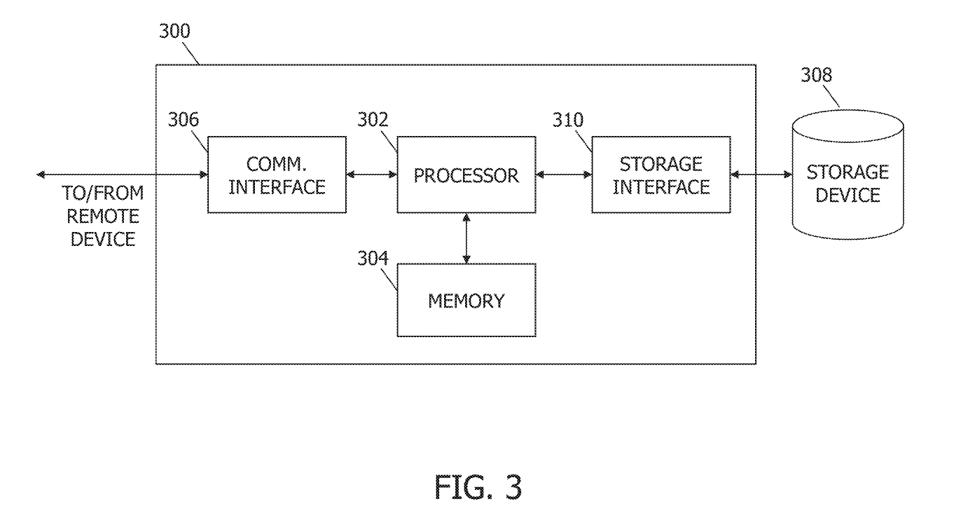

FIG. 3 illustrates an example configuration of a host system 300. Host system 300 may include, but is not limited to, payment processing server 202, valuation computing device 212, and/or host computing system 214 (all shown in FIG. 2). In the example embodiment, host system 300 determines and analyzes characteristics of payment transaction, as described below.

Host system 300 includes a processor 302 for executing instructions. Instructions may be stored in a memory area 304, for example. Processor 302 may include one or more processing units (e.g., in a multi-core configuration) for executing instructions. The instructions may be executed within a variety of different operating systems on the host system 300, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 302 is operatively coupled to a communication interface 306 such that host system 300 is capable of communicating with a remote device such as a user system or another host system 300. For example, communication interface 306 may receive authorization request messages from interchange network 108 via the Internet, as illustrated in FIG. 1.

Processor 302 may also be operatively coupled to a storage device 308. Storage device 308 is any computer-operated hardware suitable for storing and/or retrieving data. In some embodiments, storage device 308 is integrated in host system 300. For example, host system 300 may include one or more hard disk drives as storage device 308. In other embodiments, storage device 308 is external to host system 300 and may be accessed by a plurality of server systems 301. For example, storage device 308 may include multiple storage units such as hard disks or solid state disks in a redundant array of inexpensive disks (RAID) configuration. Storage device 308 may include a storage area network (SAN) and/or a network attached storage (NAS) system.

In some embodiments, processor 302 is operatively coupled to storage device 308 via a storage interface 310. Storage interface 310 is any component capable of providing processor 302 with access to storage device 308. Storage interface 310 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 302 with access to storage device 308.

Memory area 304 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

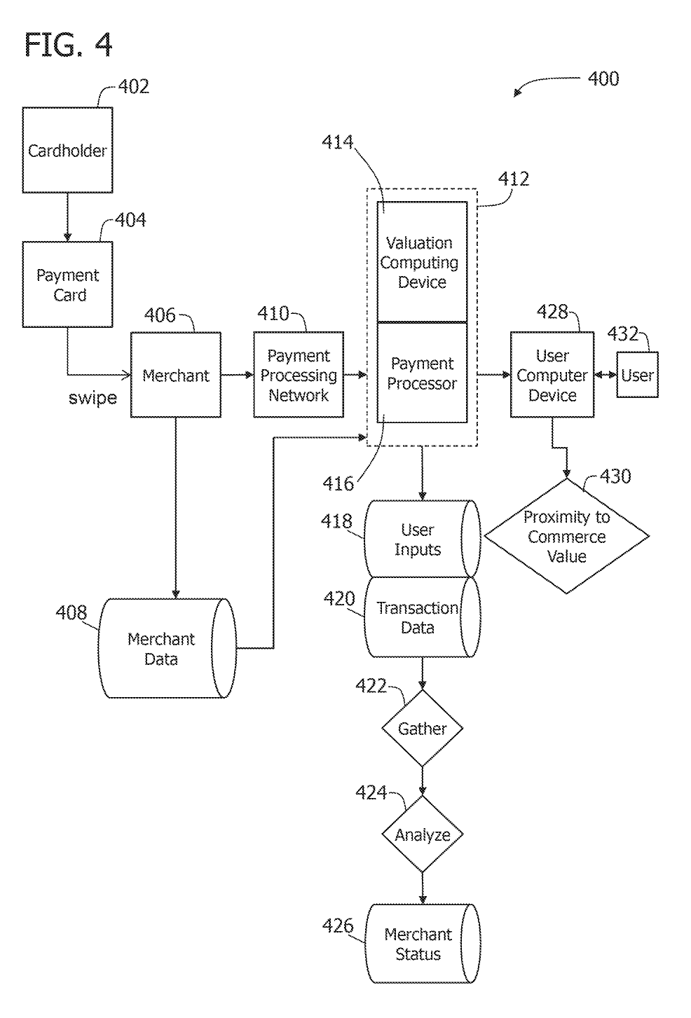

FIG. 4 depicts data flow block diagram illustrating an example of a property valuation system 400. More specifically, the data flow block diagram illustrates appraising and valuing a location value 430 based on transaction data 420. In the example embodiment, system 400 includes (a) a cardholder 402, (b) a payment card 404, (c) a merchant 406, (d) merchant data 408, (e) a payment processing network 410, (f) a host computing system 412, (g) a valuation computing device 414, (h) a payment processor 416, (i) a user input 418, (j) transaction data 420, (k) a gathering data process 422 based on user inputs received from a client system, (l) an analysis process 424 for analyzing the gathered data to determine if the transactions associated with a merchant occurred within a predetermined time period, (m) a merchant status 426, (o) a client system 428, (p) a location value 430, and (q) a user 432.

In the example embodiment, host computing system 412 includes valuation computing device 414 and payment processor 416. The functions of host computing system 412 as described herein may be performed by valuation computing device 414 and/or payment processor 416. In some embodiments, valuation computing device 414 and payment processor 416 are the same device. In other embodiments, valuation computing device and payment processor 416 are separate devices communicatively coupled to each other.

In an example embodiment, before user 432 can request a location value 430 from host computing system 412, at least one transaction must occur between cardholder 402 and merchant 406. Host computing system 412 stores transaction data 420 after the transaction between cardholder 402 and merchant 406 occurs. This transaction data 420 enables host computing system 412 to determine which merchants 406 physically located within a predefined area are operating merchants.

To gather the transaction data 420 a transaction must occur first. This process is initiated when the cardholder 402 “swipes” payment card 404 at merchant 406. When the transaction is initiated, payment processing network 410 is configured to collect transaction data 420 associated with the transaction and merchant 406 by reading payment card 404 and data associated with the merchant 406. Transaction data 420 may include, but is not limited to, an account identifier (e.g., a PAN), a cardholder name, a merchant identifier (e.g., if the merchant is a virtual or physical merchant), a merchant location identifier (e.g., a physical location if applicable), a date of the transaction, and a merchant category (e.g., restaurant, retail, and grocery). In the example embodiment, this data is transmitted to host computing system 412 during the gathering process 422 and is stored within host computing system 412 for subsequent analysis.

Host computing system 412 receives a request for property valuation from client system 428. The request from client system 428 may be submitted, for example, through a web interface or an application stored by client system 428. The request includes user inputs 418 supplied by user 432 of client system 428. In particular, user inputs 418 include a property location of a candidate property and a predefined distance from the candidate property, such as twenty miles. The predefined distance may also be a travel range or distance from the property location (e.g., a radius of ten minutes of travel by car). User inputs 418 may also include other information. For example, user inputs 418 may include infrastructure characteristics of the candidate property. The infrastructure characteristics include physical aspects of the candidate property, such as lot size, number of bedrooms, number of bathrooms, building materials, number of building levels, and a renovation history. The renovation history provides an account of at least some renovations, additions, or other changes to the candidate property.

Host computing system 412 uses the property location and the predefined distance to designate a predefined area including the property location. The predefined area identifies a geographical border or limit for the property valuation of the candidate property.

In the example embodiment, host computing system 412 calculates an impact area within the predefined area. The impact area is a geographical region including the candidate property. In the example embodiment, the impact area is calculated to include each merchant within the predefined distance. In such embodiments, host computing system 412 may analyze merchant data 408 and/or transaction data 424 or perform an online lookup to identify the merchants within the predefined area. In other embodiments, the impact area may be calculated based on other factors, such as travel distance, number of blocks from the candidate property, neighborhood limits, and the like. In certain embodiments, user 432 may selectively adjust the impact area through user inputs 418. For example, user 432 may specify a particular neighborhood or travel distance.

Host computing system 412 is configured to determine position coordinates (e.g., GPS coordinates) of the impact area and retrieve a list of merchants having a physical merchant stored within the impact area based on the determined coordinates. In some embodiments, host computing system 412 may also retrieve a list of merchants within a predetermined range of the impact area. The list of merchants may be further limited by user input 418. For example, user 432 may specify a particular merchant category, merchant trend, ticket size, and the like for each merchant within the list. Host computing system 412 is further configured to retrieve transaction data 420 associated with the list of merchants and perform analysis process 424 to verify whether or not each merchant of the list are actually still operating. More specifically, host computing system 412 analyzes recent transactions associated with each merchant to determine if the merchant is still operating within the impact area. If the transaction date of the latest transaction associated with a merchant is not within a predetermined time period (e.g., one week, one month, etc.), the merchant may not be operating within the impact area anymore (referred to as a “non-operating merchant”). Host computing system 412 may be configured to take into account holidays, business hours, temporary closures, and other such factors that may cause an operating merchant to appear to be non-operating.

The non-operating merchants are removed from the list of merchants such that only operating merchants remain within the list. In the example embodiment, host computing system 412 generates and stores a merchant status 426 (“operating” or “non-operating”) for each merchant. Accordingly, during subsequent property valuation requests for the merchants within the impact area, non-operating merchants may be identified and removed without analysis process 424 based on merchant status 426. In some embodiments, in addition to removing non-operating merchants, host computing system 412 may be configured to receive additional user inputs 418 that limit or otherwise define the list of operating merchants.

Once the operating merchants have been verified, host computing system 412 is configured to analyze transaction data 420 associated with the operating merchants to generate merchant data 408. Merchant data 408 includes information and metrics about the operating merchants to be used to calculate proximity-to-commerce value 430. At least a portion of merchant data 408 may also be retrieved from merchant 406 or another computing device (not shown) that stores data associated with merchants. Merchant data 408 may include, for example, but is not limited to, revenue, ticket size, ticket velocity, merchant category, type of merchant store (e.g., mall storefront, stand-alone building), and customer data. In some embodiments, host computing system 412 may be configured to determine a merchant category associated with each operating merchant. The customer data includes aggregated data associated with customers of the merchant, such as where the customers of the merchant reside.

Host computing system 412 is configured to compare merchant data 408 for each operating merchant to rank the merchants and indicate whether each merchant is trending up or down. In at least some embodiments, host computing system 412 is configured to compare merchant data 408 for each operating merchant to rank the merchants. In some embodiments, host computing system 412 may receive and/or generate merchant data for merchants outside of the impact area and compare the merchant data of the merchants outside of the impact area to merchant data 408. Host computing system 412 ranks the operating merchants based on the comparison. The comparisons may be performed for each merchant category such that restaurants are compared to other restaurants and gas stations and compared to other gas stations to determine merchant rankings. The merchant trends indicate a positive or negative growth of the operating merchants in a particular aspect, such as ticket size or ticket velocity. In some embodiments, transaction data 420 of the operating merchants includes current transaction data (i.e., transaction data after a predefined date threshold) and historical transaction data (i.e., transaction data before a predefined date threshold). Host computing system 412 may compare the current and historical transaction data to determine a merchant trend for each merchant. In certain embodiments, host computing system 412 may compare the operating merchants to each other or other merchants to determine relative merchant trends.

In the example embodiment, host computing system 412 is configured to determine or generate at least one proximity-to-commerce value 430 based on merchant data 408. Proximity-to-commerce value 430 may indicate a number of merchants, trends, ticket size, merchant categories, and other merchant or commerce-based information and metrics associated with the impact area and the property location. If multiple proximity-to-commerce values 430 are generated, each value 430 may be associated with a particular sub-area within the impact area and/or particular information or metrics. Proximity-to-commerce value 430 may be aggregated, calculated, or otherwise derived from at least a portion of merchant data 408. In at least some embodiments, proximity-to-commerce value 430 may be a multiplier or weighting factor of a location value component as described herein. In certain embodiments, proximity-to-commerce value 430 and/or merchant data 408 may be included with a value report (not shown in FIG. 4) that is transmitted to user 432 for review.

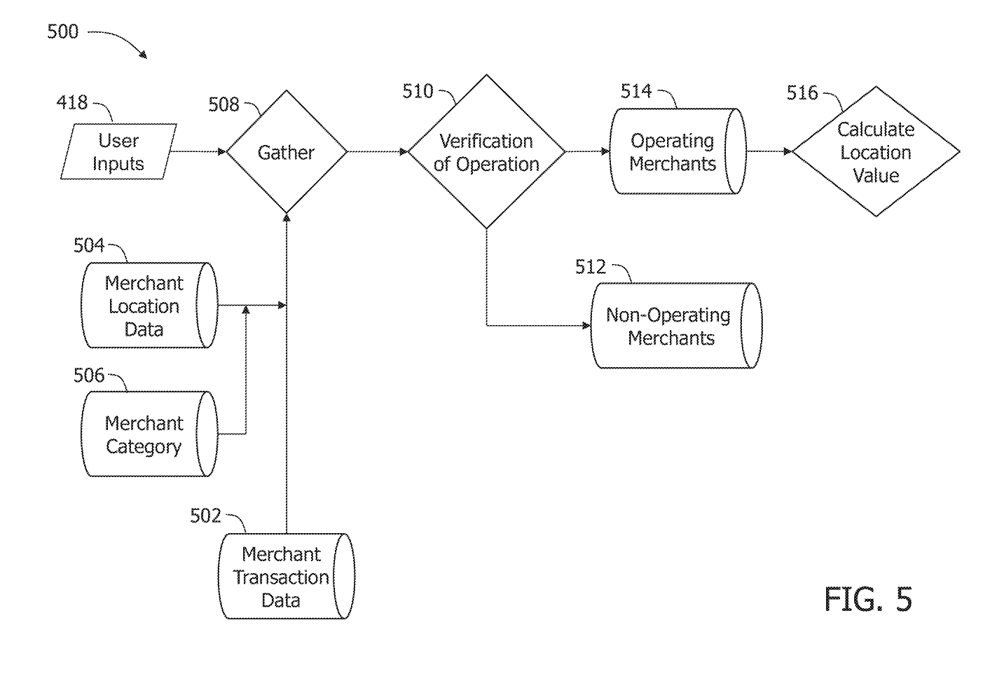

FIG. 5 is an example data flow diagram of an appraisal and valuation process 500 for determining a location value component of a property location. System 400 shown in FIG. 4 may be configured to perform process 500. Process 500 is at least partially implemented by a host computing system including a payment processor and a valuation computing device. In the example embodiment, process 500 includes (a) user inputs 418, (b) merchant transaction data 502, (c) merchant location data 504, (d) merchant category 506, (e) a data gathering process 508 based on user inputs 418, (f) operating merchant verification 510 to ensure the merchants are in business, (g) storing non-operating merchants 512, (h) storing operating merchants 514, and (i) a calculation process 516 for calculating the location value.

Process 500 begins with a client system supplying user inputs 418 to the host computing system. In response, the host computing system initiates data gathering process 508 to collect transaction data associated with merchants within an impact area including a property location of a candidate property identified by user inputs 418. The impact area is calculated based on user inputs 418. In the example embodiment, the data gathered includes merchant transaction data 502, merchant location data 504, and merchant category 506 of a plurality of merchants within the impact area. Data gathering process 508 includes assessing which merchants meet the requirements set out by the user inputs 418. The merchants that meet the requirements set out by the user inputs 418 are analyzed during operating merchant verification 510. A merchant is verified as an operating merchant 514 when the merchant has transactions that have occurred within a predetermined time period (i.e., the previous five days). In some embodiments, merchant transactions 502 are prescreened to determine which merchants are operating merchants 514. When the merchant does not have transactions within the predefined time period, the merchant is identified as a non-operating merchant 512. When the merchant has had at least one transaction within the predefined time period, the merchant is identified as an operating merchant 514. At least some operating merchants 514 are used to calculate the location value. In particular, operating merchants 514 that meet the restrictions provided by user inputs 418 are used to calculate the location value.

In the example embodiment, the location value calculation 516 includes: (i) generating merchant data for each operating merchant; (ii) calculating one or more proximity-to-commerce values based on the merchant data; and (iii) calculating the location value based, at least in part, on the proximity-to-commerce values. In at least some embodiments, the host computing system receives location-based information associated with the property location of the candidate property and the impact area, such as real estate data, median household income, neighborhood or city amenities, tax data, and so forth. The host computing system may be in communication with a computing device or database that includes the location-based information. Based on the data received and generated by the host computing system, a location value is calculated. The location value component may be a score or other metric for measuring the value of the location of the candidate property. In one embodiment, the proximity-to-commerce value is a weighting factor that is applied to the location value component.

In some embodiments, the location value calculation 516 further includes examining and weighting merchant data such as the ticket size of the average transactions at operating merchants 514. For example, an average ticket size of $100 for operating merchants 514 generally would indicate a high-end area and would increase the location value. In other embodiments, merchant traffic (e.g., a high number of average transactions per hour) affects the location value calculation 516. For example, an area may have a high number of operating merchants 514 but the transactions per hour may be one transaction per hour. While the average number of operating merchants 514 within the area will increase the location value, the low number of average transactions per hour will decrease the location value. In some embodiments, the host computing system uses historical transaction data along with current transaction data to determine if the number of operating merchants 514 is increasing or decreasing. Typically, when the number of operating merchants 514 within the location is increasing over time, the location has an increasing merchant growth, and the location value increases as a result. In another instance, if a parcel of land may be zoned for raising livestock, the value of the land increases when there is a feed store nearby, the location value 430 increase when a feed store is close even if the number of operating merchants 514 within the area is low.

In one example, user inputs 418 are received at the host computing system from a client system. These user inputs 418 may include a property location, a distance range and a merchant category. For example, user inputs 418 may be 123 Capital Drive, St. Louis, Mo., 63105, 3 miles, and restaurant. In the example embodiment, the host computing system retrieves merchant location data 504 for merchants within 3 miles of 123 Capital Drive, St. Louis, Mo. 63105. In this example, 3 miles refers to a diameter with 123 Capital Drive as the center. In other embodiments, 3 miles may refer to a circumference, a radius or other representation of determining area. Once the merchants within the area are identified, merchant categories 506 for the merchants are examined. The merchants within the determined area with merchant category 506 matching restaurant are kept. The merchants that meet the requirements (i.e., merchants within a 3 mile diameter of the property location that are restaurants) are stored along with their corresponding transaction data 502 by the host computing system. Transaction data 502 is then used to determine if the latest transaction of each merchant occurred within a predetermined time period. The host computing system generates and/or collect merchant data associated with merchants identified as operating merchants. From there, the merchant data may be analyzed to assist in calculating a proximity-to-commerce value and a location value using calculation process 516.

In some embodiments, merchant transaction data 502 may be prescreened. This prescreening by the host computing system identifies and stores only merchant transactions occurring within the predefined time period within merchant transaction data 502 in memory. The operating merchant verification 514 would not need to be performed in such embodiments.

In at least some embodiments, the location value calculation 516 may use additional user inputs 418 received by the host computing system when determining the location value. For example, a parcel of land may be evaluated. While the parcel of land may be far from any commerce it may be zoned for an activity that increases the value of the land when the land is located away from a populated location. The location value calculation 516 may then take into account the activity that will take place on the parcel of land and account for this by increasing the location value calculation 516 when there are fewer operating merchants within the area.

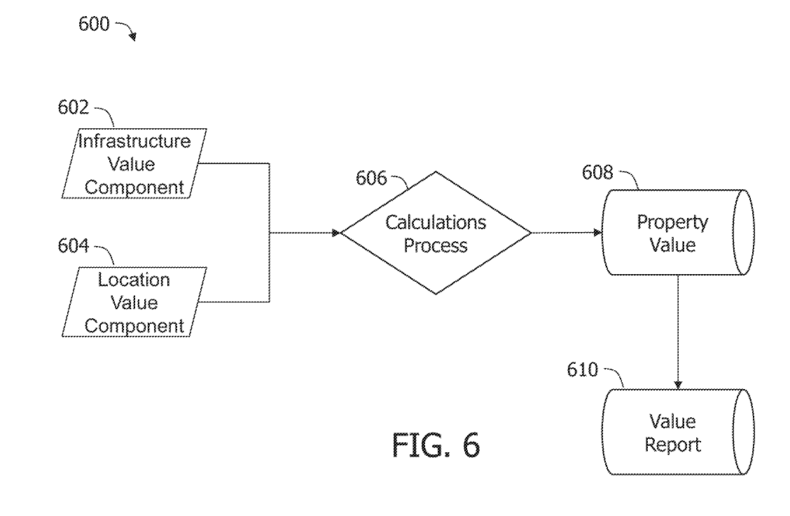

FIG. 6 is an example data flow diagram depicting a property value appraisal process 600. More specifically, process 600 generates an overall value for the property location, property value 608. Process 600 may be performed by a host computing system, such as host computing system 400 shown in FIG. 4. Process 600 includes (a) an infrastructure value component 602, (b) a location value component 604, (c) a calculation process 606 and (d) a property value 608. In other embodiments, process 600 may include additional, fewer, or alternative steps, including those described elsewhere herein.

Infrastructure value 602 represents the value of a candidate property at the property location. In the example embodiment, infrastructure characteristics are received or retrieved by the host computing system to determine infrastructure value component 602. The infrastructure characteristics may include, but are not limited to: (a) a number of rooms, (b) a number of bathroom, (d) a square footage, (e) a building age, (f) renovation history (i.e., cosmetics, plumbing, and/or electric updates), and (g) a lot size. In instances where the property location is a lot and has no building, data may include (a) a lot size, (b) zoning of lot, and (c) previous activity on the lot.

In the example embodiment, the host computing system performs process 600 after location value component 604 is determined. In the example embodiment, location value component 604 is determined by assessing the proximity-to-commerce and other location-based information associated with the property location. Location value component 604 may be a score, metric, price, or other quantitative data.

To perform process 600, in the example embodiment, the host computing system retrieves infrastructure value component 602 and location value component 604 to perform calculation process 606. Calculation process 606 adds location value component 604 to infrastructure value component 604 to determine property value 608. For example, if infrastructure value component 602 is $200,000 and location value component 704 is $10,000 the property value 608 is $200,000+$10,000=$210,000. In other embodiments, calculation process 606 may determine property value 608 by aggregating, deriving, and otherwise calculating property value 608 based on infrastructure component 602 and location value component 604.

In the example embodiment, the host computing system is configured to generate a value report 610 for a user requesting the valuation of the candidate property. Value report 610 includes at least a portion of information retrieved and/or generated by the host computing system about the candidate property and a corresponding impact area. In particular, value report 610 may include property value 608, location value component 604, infrastructure value component 602, a proximity-to-commerce value, and merchant data associated with operating merchants within the impact area. The host computing system causes value report 610 to be displayed on an interactive display (not shown) of a client system to enable the user to access, review, and interact with value report 610. For example, value report 610 may be configured to enable the user to filter value report 610 to data associated with a specific merchant category. In another example, value report 610 may include a visual representation of the impact area that the user may select a sub-region of the impact area to limit the displayed data of value report 610 to that specific sub-region. The user can analyze value report 610 to make informed decisions (e.g., buy, sell, rent, lease, etc.) about the candidate property or other properties near the candidate property.

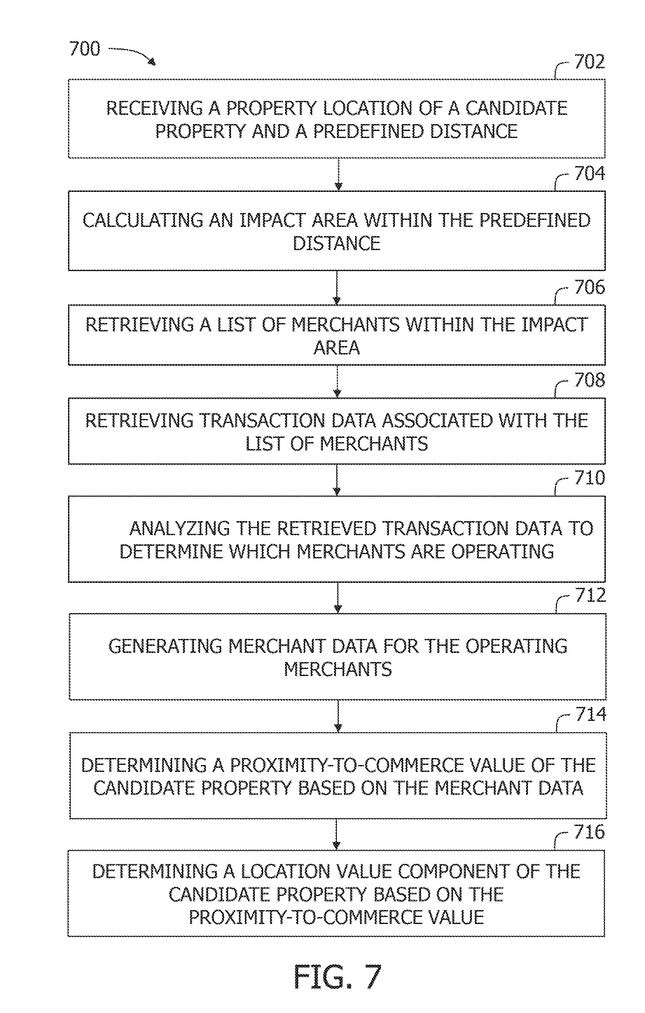

FIG. 7 is a depiction of an example computer-implemented method 700 for determining a location value component of an overall value or property value of a candidate property. In at least some embodiments, method 700 is performed by a host computing system (e.g., host computing system 412, shown in FIG. 4). In other embodiments, method 700 may include additional, fewer, or alternative steps to perform the functions described herein.

Host computing system 412 initiates method 700 by receiving 702 a property location of a candidate property and a predefined distance from a client device. Host computing system 412 calculates 704 an impact area within the predefined distance. The impact area may be defined by a number of blocks, distance, travel distance, or other factors. The impact area includes the property location and at least one merchant. Host computing system 412 retrieves 706 a list of merchants within the impact area for analysis. In addition, host computing system 412 retrieves 708 transaction data associated with the retrieved list of merchants. In at least some embodiments, host computing system 412 retrieves 706, 708 the list of merchants and the transaction data from a database associated with a payment processor.

Host computing system 412 analyzes 710 the retrieved transaction data to determine which merchants within the impact area are operating merchants. In particular, host computing system 412 analyzes a transaction date of the latest transaction of each merchant. If the transaction date is within a predetermined period of time (e.g., the past five days), then the merchant is identified as an operating merchant. Otherwise, the merchant is identified as a non-operating merchant. Once the operating merchants are identified, host computing system 412 generates 712 merchant data for the operating merchants based on the retrieved transaction data associated with the operating merchants. In some embodiments, at least a portion of the merchant data may be retrieved by host computing system 412 from the merchant or a database storing information associated with merchants. Host computing device 412 determines 714 a proximity-to-commerce value component for the candidate property based on the generated merchant data. Based at least in part on the proximity-to-commerce value component, host computing system 412 determines 716 a location value component associated with the candidate property. In certain embodiments, the proximity-to-commerce value component is a weighting factor applied to the location value component.

In at least some embodiments, host computing system 412 may further determine an infrastructure value component based on infrastructure characteristics of the candidate property. Host computing system 412 may further determine a property value of the candidate property based on the location value component and the infrastructure value component. In some embodiments, host computing system 412 generates a value report based on at least one of the merchant data, the proximity-to-commerce value component, the location value component, the infrastructure component, and the property value.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A valuation computing device for optimizing a valuation of a property, said valuation computing device comprising a processor coupled to a memory and a database, the processor programmed to:
receive a property location of a candidate property and a predefined distance, the predefined distance defining a geographical area including the property location;
calculate an impact area within the predefined distance, the impact area including at least one merchant;
retrieve, from the database, a list of merchants within the impact area;
retrieve, from the database, transaction data associated with the retrieved list of merchants;
analyze the retrieved transaction data to determine which merchants of the retrieved list of merchants are currently operating;
generate merchant data for the operating merchants based on the transaction data associated with the operating merchants; and
determine a proximity-to-commerce value component for the candidate property based on the generated merchant data.

2. The valuation computing device in accordance with claim 1, wherein the processor is further programmed to determine an overall value of the candidate property by determining an infrastructure value component of the candidate property and a location value component of the candidate property, the location value component including the proximity-to-commerce value component.

3. The valuation computing device in accordance with claim 2, wherein the processor is further programmed to:
generate a value report associated with the candidate property, the value report including at least one of the overall value, the location value component, the infrastructure value component, the proximity-to-commerce value component, and the merchant data;
transmit the value report to a client device; and
cause the value report to be displayed on an interactive display of the client device.

4. The valuation computing device in accordance with claim 2, wherein the processor is further programmed to:
receive real estate data associated with the impact area; and
determine the location value component based on the real estate data and the proximity-to-commerce value component, wherein the proximity-to-commerce value component is a multiplier applied to the location value component.

5. The valuation computing device in accordance with claim 1, wherein the processor is further programmed to:
determine position coordinates associated with the impact area; and
retrieve the list of merchants based on the determined position coordinates.

6. The valuation computing device in accordance with claim 1, wherein the processor is further programmed to:
analyze a transaction date of a latest transaction from the retrieved transaction data for each merchant of the retrieved list of merchants; and
determine that the transaction date of the latest transaction for at least a first portion of the retrieved list of merchants is within a predetermined period of time, wherein the first portion of the retrieved list of merchants are identified as operating merchants.

7. The valuation computing device in accordance with claim 1, wherein the transaction data includes current transaction data and historical transaction data, wherein the processor is further programmed to:
compare the current transaction data and the historical transaction data;
determine a merchant trend for each operating merchant of the operating merchants based on the comparison, the merchant trend indicating a positive or negative growth of the operating merchant, wherein the merchant data includes the merchant trend.

8. The valuation computing device in accordance with claim 1, wherein the processor is further programmed to:
receive merchant data associated with merchants outside of the impact area;
compare the merchant data of the operating merchants within the impact area to the merchant data associated with the merchants outside of the impact area; and
generate merchant rankings for the operating merchants based on the comparison, wherein the merchant rankings are included in the merchant data of the operating merchants.

9. The valuation computing device in accordance with claim 1, wherein the processor is further programmed to:
determine a merchant category for each operating merchant based on the transaction data;
compare the merchant data of the operating merchants associated with a first merchant category; and
determine merchant rankings associated with the first merchant category based on the comparison, wherein the merchant rankings are included in the merchant data of the operating merchants associated with the first merchant category.

10. The valuation computing device in accordance with claim 1, wherein the merchant data for each operating merchant includes at least one of a ticket size, a ticket velocity, a merchant category, a merchant trend, and a merchant ranking.

11. A method for optimizing a valuation of a property, the method comprising:
receiving, by a valuation computing device, a property location of a candidate property and a predefined distance, the predefined distance defining a geographical area including the property location;
calculating an impact area within the predefined distance, the impact area including at least one merchant;
retrieving, from a database, a list of merchants within the impact area;
retrieving, from the database, transaction data associated with the retrieved list of merchants;
analyzing, by the valuation computing device, the retrieved transaction data to determine which merchants of the retrieved list of merchants are currently operating;
generating merchant data for the operating merchants based on the transaction data associated with the operating merchants; and
determining, by the valuation computing device, a proximity-to-commerce value component for the candidate property based on the generated merchant data.

12. The method in accordance with claim 11 further comprising determining, by the valuation computing device, an overall value of the candidate property by determining an infrastructure value component of the candidate property and a location value component of the candidate property, the location value component including the proximity-to-commerce value component.

13. The method in accordance with claim 12 further comprising:
generating, by the valuation computing device, a value report associated with the candidate property, the value report including at least one of the overall value, the location value component, the infrastructure value component, the proximity of commerce value component, and the merchant data;
transmitting the value report to a client device; and
causing the value report to be displayed on an interactive display of the client device.

14. The method in accordance with claim 12, wherein determining the overall value further comprises:
receiving real estate data associated with the impact area; and
determining, by the valuation computing device, the location value component based on the real estate data and the proximity-to-commerce value component, wherein the proximity-to-commerce value component is a multiplier applied to the location value component.

15. The method in accordance with claim 11, wherein retrieving the list of merchants further comprises:
determine position coordinates associated with the impact area; and
retrieve the list of merchants based on the determined position coordinates.

16. The method in accordance with claim 11, wherein analyzing the retrieved transaction data to determine which merchants are currently operating further comprises:
analyzing, by the valuation computing device, a transaction date of a latest transaction from the retrieved transaction data for each merchant of the retrieved list of merchants; and
determining that the transaction date of the latest transaction for at least a first portion of the retrieved list of merchants is within a predetermined period of time, wherein the first portion of the retrieved list of merchants are identified as operating merchants.

17. The method in accordance with claim 11, wherein the transaction data includes current transaction data and historical transaction data, wherein generating the merchant data further comprises:
comparing the current transaction data and the historical transaction data;
determining a merchant trend for each operating merchant of the operating merchants based on the comparison, the merchant trend indicating a positive or negative growth of the operating merchant, wherein the merchant data includes the merchant trend.

18. The method in accordance with claim 11, wherein generating the merchant data further comprises:
receiving, by the valuation computing device, merchant data associated with merchants outside of the impact area;
comparing the merchant data of the operating merchants within the impact area to the merchant data associated with the merchants outside of the impact area; and
generating merchant rankings for the operating merchants based on the comparison, wherein the merchant rankings are included in the merchant data of the operating merchants.

19. The method in accordance with claim 11, wherein generating the merchant data further comprises:
determining, by the valuation computing device, a merchant category for each operating merchant based on the transaction data;
comparing the merchant data of the operating merchants associated with a first merchant category; and
determining merchant rankings associated with the first merchant category based on the comparison, wherein the merchant rankings are included in the merchant data of the operating merchants associated with the first merchant category.

20. The method in accordance with claim 11, wherein the merchant data for each operating merchant includes at least one of a ticket size, a ticket velocity, a merchant category, a merchant trend, and a merchant ranking.

21. At least one non-transitory computer-readable storage media having computer-executable instructions embodied thereon, wherein when executed by at least one processor, the computer-executable instructions cause the processor to:
receive a property location of a candidate property and a predefined distance, the predefined distance defining a geographical area including the property location;
calculate an impact area within the predefined distance, the impact area including at least one merchant;
retrieve, from a database, a list of merchants within the impact area;
retrieve, from the database, transaction data associated with the retrieved list of merchants;
analyze the retrieved transaction data to determine which merchants of the retrieved list of merchants are currently operating;
generate merchant data for the operating merchants based on the transaction data associated with the operating merchants; and
determine a proximity-to-commerce value component for the candidate property based on the generated merchant data.

22. The computer-readable storage media in accordance with claim 21, wherein the computer-executable instructions further cause the processor to determine an overall value of the candidate property by determining an infrastructure value component of the candidate property and a location value component of the candidate property, the location value component including the proximity-to-commerce value component.

23. The computer-readable storage media in accordance with claim 22, wherein the computer-executable instructions further cause the processor to:
generate a value report associated with the candidate property, the value report including at least one of the overall value, the location value component, the infrastructure value component, the proximity-to-commerce value component, and the merchant data;
transmit the value report to a client device; and
cause the value report to be displayed on an interactive display of the client device.

24. The computer-readable storage media in accordance with claim 22, wherein the computer-executable instructions further cause the processor to:
receive real estate data associated with the impact area; and
determine the location value component based on the real estate data and the proximity-to-commerce value component, wherein the proximity-to-commerce value component is a multiplier applied to the location value component.

25. The computer-readable storage media in accordance with claim 21, wherein the computer-executable instructions further cause the processor to:
determine position coordinates associated with the impact area; and
retrieve the list of merchants based on the determined position coordinates.

26. The computer-readable storage media in accordance with claim 21, wherein the computer-executable instructions further cause the processor to:
analyze a transaction date of a latest transaction from the retrieved transaction data for each merchant of the retrieved list of merchants; and
determine that the transaction date of the latest transaction for at least a first portion of the retrieved list of merchants is within a predetermined period of time, wherein the first portion of the retrieved list of merchants are identified as operating merchants.

27. The computer-readable storage media in accordance with claim 21, wherein the transaction data includes current transaction data and historical transaction data, wherein the computer-executable instructions further cause the processor to:
compare the current transaction data and the historical transaction data;
determine a merchant trend for each operating merchant of the operating merchants based on the comparison, the merchant trend indicating a positive or negative growth of the operating merchant, wherein the merchant data includes the merchant trend.

28. The computer-readable storage media in accordance with claim 21, wherein the computer-executable instructions further cause the processor to:
receive merchant data associated with merchants outside of the impact area;
compare the merchant data of the operating merchants within the impact area to the merchant data associated with the merchants outside of the impact area; and
generate merchant rankings for the operating merchants based on the comparison, wherein the merchant rankings are included in the merchant data of the operating merchants.

29. The computer-readable storage media in accordance with claim 21, wherein the computer-executable instructions further cause the processor to:
determine a merchant category for each operating merchant based on the transaction data;
compare the merchant data of the operating merchants associated with a first merchant category; and
determine merchant rankings associated with the first merchant category based on the comparison, wherein the merchant rankings are included in the merchant data of the operating merchants associated with the first merchant category.

30. The computer-readable storage media in accordance with claim 21, wherein the merchant data for each operating merchant includes at least one of a ticket size, a ticket velocity, a merchant category, a merchant trend, and a merchant ranking.
